(19) United States
(12) Patent Application Publication
(10) Pub. No.: US 2021/0061704 A1
(43) Pub. Date: Mar. 4, 2021

(54) MONOLITHIC INTERLEAVING MATERIAL

(71) Applicant: Fredrik Johnson, Lino Lakes, MN (US)

(72) Inventor: Fredrik Johnson, Lino Lakes, MN (US)

(21) Appl. No.: 17/003,758

(22) Filed: Aug. 26, 2020

Related U.S. Application Data
(60) Provisional application No. 62/895,329, filed on Sep. 3, 2019.

(51) Int. Cl. C03C 17/32; C08K 5/098

(52) U.S. Cl. CPC C03C 17/32; C03C 2218/11; C03C 2217/78; C08K 5/098

(57) ABSTRACT

Embodiments of the present disclosure describe monolithic interleaving materials and related methods. An interleaving material may include an interleaving particle or bead enrobed or impinged with stain-inhibiting organic acids or salts thereof. An interleaving material may include an interleaving particle or bead, wherein the interleaving particle or bead comprises an cation exchange resin, wherein the cation exchange resin is configured to sequester cations leached from glass. An interleaving material may include a functionalized porous media comprising functional groups that scavenge or react with ions leached from glass. A method of applying interleaving materials may include disposing a plurality of interleaving materials onto a surface of a glass article.

### BACKGROUND OF THE INVENTION

It is known in the art that glass articles are susceptible to marring and corrosion while being, for example, transported and stored. Such damage can be caused by contact with neighboring glass articles and other objects, as well as chemical reactions in which the chemical bonds forming the glass are broken or destroyed, thereby dissolving the glass and staining the surfaces thereof. Damage to the glass is a prevalent concern in stacked glass sheets in which a plurality of glass sheets are arranged or packed in a general face-to-face orientation. The stacked orientation of the glass sheets can increase the frequency of contact between adjacent sheets, causing marring. Marring can be particularly pronounced in stacks comprising glass sheets with pyrolytic deposited metal oxide and silicon-containing coatings thereon. In addition, the environmental conditions under which stacked glass sheets are transported and/or stored, which are difficult to control, can lead to corrosion. For example, it is known that soda-lime-silica glass corrodes at alkaline pH levels of 9 or greater in the presence of water. The water can cause sodium ions to leach from within the glass, forming sodium hydroxide, thereby increasing the pH level.

### SUMMARY OF THE INVENTION

Improved interleaving materials for separating and protecting glass sheets during transportation, storage, and the like are disclosed herein.

According to one or more aspects of the invention, a stain-inhibiting interleaving material may include an interleaving polymer-containing particle or bead enrobed or impinged with stain-inhibiting organic acids or salts thereof.

According to one or more aspects of the invention, a stain-inhibiting interleaving material may include an interleaving particle or bead, wherein the interleaving particle or bead comprises a cation exchange resin, wherein the cation exchange resin is configured to sequester cations leached from glass.

According to one or more aspects of the invention, a stain-inhibiting interleaving material may include an interleaving material, wherein the interleaving material comprises a functionalized porous media comprising functional groups that scavenge or react with ions leached from glass.

According to one or more aspects of the invention, a method of applying a stain-inhibiting interleaving material may include disposing a plurality of interleaving materials onto a surface of a glass article.

The details of one or more examples are set forth in the description below. Other features, objects, and advantages will be apparent from the description and from the claims.

### DETAILED DESCRIPTION

The present invention relates to improved interleaving materials for separating and protecting glass sheets during transportation, storage, and the like. The interleaving materials combine the mechanical separation and stain inhibiting capacity of conventional materials into a single particle. For example, the interleaving materials can be utilized for preventing or retarding the formation of stains on the surfaces of glass sheets and physically or mechanically separating adjacent glass sheets during transit or storage, among other situations. As one example, the interleaving materials of the present disclosure may slow sodium ion exchange rates (e.g., by maintaining about neutral pH) and/or by neutralizing sodium hydroxide formed when water is present among other types of corrosive and/or staining materials. In addition, the interleaving materials can adhere or lightly bind to the surfaces of both coated and uncoated glass sheets, thereby minimizing waste and reducing over application. During transportation or storage of stacked glass sheets, the interleaving materials can provide superior protection and resistance to marring and scratches, while also inhibiting or preventing staining of the glass surfaces. For example, some embodiments include interleaving materials that scavenge select ions, thereby precluding the formation of alkaline species that lead to staining. The interleaving materials can also be utilized to separate glass sheets without creating a vacuum seal that prevents the disassembly and separation of stacked glass sheets. In this way, the interleaving materials disclosed herein overcome the challenges and shortcomings of conventional materials.

### Definitions

The terms recited below have been defined as described below. All other terms and phrases in this disclosure shall be construed according to their ordinary meaning as understood by one of skill in the art.

As used herein, the term “stacked glass sheets” refers to a plurality of glass sheets, which can be coated or uncoated, stacked adjacent to one another with a face-to-face orientation. The stacking can be characterized as a vertical stacking, horizontal stacking, or inclined stacking.

As used herein, the terms “enrobed,” “enrobe,” “enrobing,” and the like refer to covering at least a portion of a surface of an interleaving material with a stain-inhibiting material. For example, an enrobed material can refer to a particle or bead having a stain-inhibiting organic acid coating deposited on at least a portion of the particle or bead. In another example, the term enrobing can refer to processes in which at least a portion of a particle or bead is coated with a stain-inhibiting organic acid. Materials can be enrobed by any of a variety of techniques. Suitable techniques for enrobing include, but are not limited to, spray drying, atomization, deposition, and the like. The term enrobing includes encapsulating, coating, depositing, covering, sorbing (e.g., absorbing, adsorbing, desorbing, etc.), and the like.

As used herein, the terms “impinged,” “impinge,” “impinging,” and the like refer to covering at least a portion of an interior surface of an interleaving material with a stain-inhibiting material. For example, an impinged material can refer to a porous particle or bead in which a stain-inhibiting organic acid is present in at least a portion of the pores of said particle or bead. In another example, the term impinging can refer to a a process and/or material in which a porous particle or bead is impregnated, infused, and/or saturated with a stain-inhibiting organic acid. In a further example, an impinged material can refer to a porous particle or bead in which a stain-inhibiting organic acid component is at least partially pressed into a surface of said particle or bead (e.g., may be immobilized, associated, and/or connected therewith). Materials can be impinged by any of a variety of techniques. Suitable techniques for impinging include, but are not limited to, spray drying, atomization, deposition, immersion, wetness incipient impregnation, and the like. The term “impinging” includes penetrating, injecting, diffusing, sorbing (e.g., absorbing, adsorbing, desorbing, etc.), incorporating, and the like.

As used herein, the term “weak organic acid” refers to an organic acid that only slightly dissociates in aqueous solution or an acid reacting salt that dissolves in water to form an acidic solution. Examples of suitable organic acids include, but are not limited to, acids containing 3 to 10 carbon atoms, especially (i) dibasic aliphatic acids, for example adipic acid, maleic acid, sebacic acid and succinic acid and (ii) aromatic acids, for example benzoic acid and salicylic acid. If desired, a mixture of weakly acidic materials may be used. The weak organic acids used in the practice of the present invention have a first dissociation constant, measured at 25° C., in the range 1×10⁻¹ to 1×10⁻⁷, the preferred organic acids having a first dissociation constant, measured at 25° C., in the range 5×10⁻³ to 1×10⁻⁶.

As used herein, the term “alkali” refers to metals including lithium, sodium, potassium, rubidium, caesium, and francium. The alkali metals can be present in ionic or elemental form.

As used herein, the term “alkaline earth metal” refers to metals including calcium, magnesium, beryllium, strontium, barium, and radium. The metals can be present in ionic or elemental form.

As used herein, the term “neutralize” or “neutralizing” or “neutralization” and the like refer to chemical reactions between an alkaline species with an acidic species, which is preferably the stain-inhibiting organic acids disclosed herein, but can include other acidic species known in the art.

As used herein, the term “sequester” refers to the exchange of ions using, for example, ion exchange resins. For example, ions leached from glass can be sequestered using ion exchange resins, where a mobile ion from the ion exchange resin is exchanged with the ion leached from the glass.

As used herein, the term “scavenger” refers to a material that is reactive towards an ion leached from glass. Scavengers can be utilized to prevent the formation of alkaline species that can result in staining of glass surfaces. The term “scavenging” is related and refers to reacting with ions leached from glass.

Embodiments of the present disclosure include without limitation neutralizing stain-inhibiting interleaving materials, sequestering stain-inhibiting interleaving materials, scavenger stain-inhibiting interleaving materials, methods of applying stain-inhibiting interleaving materials, and the like.

### NEUTRALIZING INTERLEAVING MATERIALS

Embodiments of the present disclosure include interleaving materials comprising interleaving particles or beads enrobed or impinged with stain-inhibiting organic acids or salts thereof. In some embodiments, the interleaving particles or beads include one or more of polymers, ceramics, metals, fabrics, etc. For example, in some embodiments, the interleaving particles or beads include polymer-containing particles and/or beads. For example, in some embodiments, the interleaving materials comprise polymer-containing interleaving particles or beads. The enrobing or impinging of the interleaving polymer-containing particles or beads with the stain-inhibiting organic acids or salts thereof can be achieved through chemical or physical adherence or bonding, or any combination thereof.

Porous or non-porous interleaving polymer-containing particles or beads can be used herein. For example, porous polymer-containing particles or beads may be selected for interleaving materials impinged with the stain-inhibiting organic acid or salt thereof. Either porous or non-porous polymer-containing particles or beads may be selected for interleaving materials enrobed with the stain-inhibiting organic acid or salt thereof. In some embodiments, the interleaving polymer-containing particles or beads can be chemically inert materials. The forms in which the interleaving polymer-containing particles are provided can include various solid forms, such as powders, as well as larger forms, such as beads. Accordingly, the particle size or average particle size of the interleaving polymer containing particles or beads is not particularly limited and can be in the range of about 0.01 micron to about 3 cm, or any range or value thereof. The interleaving polymer-containing particles or beads, whether porous or non-porous, can be utilized as a support for the stain-inhibiting material. Further, the interleaving polymer-containing particles or beads are mechanically strong, sufficient to withstand the pressures and other forces that are present between glass articles, such as stacked glass sheets, of any size, to provide the requisite physical separation between adjacent glass surfaces.

Suitable interleaving polymer-containing particles or beads can include, but are not limited to, polymethylmethacrylate, polyethylene, polystyrene, polytetrafluoroethylene, polyvinylpyrrolidone, acrylic beads, nylon, polypropylene, polypropylene glycol (PPG), polyethylene, divinylbenzene, polyvinyl, polyvinyl difluoride, high density polyvinyl difluoride, polyacrylamide, phenolic resins, melamine resins, epoxy resins, silicone resins, polyimides, a (C2-C6) monoolefin polymer, a vinylaromatic polymer, a vinylaminoaromatic polymer, a vinylhalide polymer, a (C1-C6) alkyl (meth)acrylate polymer, a(meth)acrylamide polymer, a vinyl pyrrolidone polymer, a vinyl pyridine polymer, a (C1-C6)hydroxyalkyl (meth)acrylate polymer, a (meth)acrylic acid polymer, an acrylamidomethylpropylsulfonic acid polymer, an N-hydroxy-containing (C1-C6) alkyl(meth)acrylamide polymer, acrylonitrile; polyesters, such as polyglycolide, polylactic acid, polycaprolactone, polyethylene adipate, polyhydroxylalkanoate, polyhydroxybutyrate, poly(3-hydroxybutyrate-co-3-hydroxyvalerate), polyethylene terephthalate, polybutylene terephthalate, polytrimethylene terephthalate, and polyethylene naphthalate; cellulose, either as natural cellulose fibers or cellulose fiber derivatives including cellulose esters (e.g., nitrocellulose, cellulose acetate, cellulose triacetate, cellulose propionate, cellulose acetate propionate, cellulose acetate butyrate, and cellulose sulfate) and cellulose ethers (e.g., methylcellulose, ethylcellulose, ethyl methyl cellulose, hydroxyethyl cellulose, hydroxyethyl methyl cellulose, hydroxypropyl methyl cellulose, ethyl hydroxyethyl cellulose, and carboxymethyl cellulose); and the like. In some embodiments, the interleaving polymer-containing particles or beads include cellulose polymer particles, such as cellulose polymer particles from the rayon group including one or more of viscose, modal, and lyocell. In some embodiments, the cellulose polymer particles include rayon cellulose, viscose cellulose, lyocell cellulose, and modal cellulose, among others.

The interleaving particles and/or beads may include a coating, such as a surface coating. In some embodiments, the coating is utilized to promote adhesion (e.g., enrobing, impinging, etc.) of the stain-inhibiting organic salts and/or salts of stain-inhibiting organic acids. In some embodiments, the coating is utilized as a static eliminator. For example, in some embodiments, the coating is utilized to promote improved screenability (e.g., based on particle size). In some embodiments, the coating permits use of materials other than diatomaceous earth. In some embodiments, the coating removes the need for spray drying or any other sort of water management steps. In some embodiments, the coating includes polypropylene glycol (PPG). In some embodiments, the coating includes polyethylene glycol (PEG). In some embodiments, the coating includes one or more of polyglycols include polypropylene glycol (PPG) and polyethylene glycol (PEG); poly(lactone)polyols include poly(caprolactone)diol; polycarboxylic acids include polyacrylic acid (PAA); polyamides include polyacrylamide or polypeptides; polyamines include polyethylenimine and polyvinylpyridine; polysulfonic acids or polysulfonates include poly(sodium-4-styrenesulfonate) or poly(2-acrylamido-methyl-1-propanesulfonic acid); and copolymers thereof (for example a polypropyleneglycol/polyethylene glycol copolymer).

The stain-inhibiting organic acid and salts thereof can be selected to neutralize alkaline species formed on or near the glass surface. For example, in some embodiments, a slow reaction can occur in which water reacts with alkali ions to form hydroxides. The presence of hydroxides increases the surface pH. Once the pH levels include to a pH of about 9 or greater, staining of the glass surface can result from severing of, for example, silicon-oxygen bonds. However, in the presence of an acid, the hydroxides can be neutralized, reducing staining of the glass or preventing it all together. Ions that can leach out of glass and cause staining are known in the art. Non-limiting examples of such ions include sodium, potassium, iron, manganese, boron, aluminum, and copper, among others, including ions from compounds incorporated into stained glass to provide color. In some embodiments, the ions include alkali ions, alkaline earth ions, or a combination thereof. All ions are intended to be within the scope of the present disclosure.

The stain-inhibiting organic acid can be selected from organic acids or salts thereof capable of neutralizing alkaline species, such as hydroxides. The stain-inhibiting organic acids may be provided in solid form, liquid form, gaseous form, or a combination thereof. In some embodiments, for example, the stain-inhibiting organic acids are provided in solid form, such as in the form of a powder, among other solid forms. In some embodiments, the solid form includes powder form, wherein the powder form is free flowing powder and/or maintains its form in the presence of moisture/ambient conditions/etc. In some embodiments, the stain-inhibiting organic acids include spray dried stain-inhibiting organic acids. In some embodiments, suitable stain-inhibiting organic acids can include acids containing at most 20 carbon atoms, including aliphatic acids and aromatic acids, either or both of which can be substituted or unsubstituted. Examples of suitable substituents include, but are not limited to, hydroxy (—OH), carboxylic (—COOH), sulfo (—SO₃H), phosphates (—PO₄H₂), sulfhydryl (—SH), and amino (—NH₂), among others. In some embodiments, the stain-inhibiting organic acids include carboxylic acids. For example, the stain-inhibiting organic acids can include monocarboxylic acids, dicarboxylic acids, tricarboxylic acids, and tetracarboxylic acids. In some embodiments, the stain-inhibiting organic acids comprise hydroxy acids, or acids comprising hydroxyl groups and carboxyl groups. For example, the stain-inhibiting organic acids can include hydroxy carboxylic acids, such as hydroxy monocarboxylic acids, hydroxy dicarboxylic acids, hydroxy tricarboxylic acids, hydroxy tetracarboxylic acids, and so on. Non-limiting examples of suitable stain-inhibiting organic acids include gluconic acid, stearic acid, palmitic acid, citric acid, tartaric acid, malic acid, DL-tropic acid, glyceric acid, aldonic acids, maleic acid, sebacic acid, succinic acid, saccharic acid, mannaric acid, salicylic acid, adipic acid, stearic acid, itaconic acid, lactic acid, sodium acetate, boronic acid, fumaric acid, benzoic acid, oganotin compounds such as oganotin halides, alkyltin halides such as methyltin trichloride and dimethyltin dichloride, sodium bisulfate, and the like. Examples of salts of organic acids include sodium salts, potassium salts, ammonium salts, calcium salts, magnesium salts, and the like. In some embodiments, for example, the stain-inhibiting organic acid includes sodium salts, such as sodium salts of gluconic acid and/or citric acid and/or sodium gluconate and/or sodium citrate (e.g., disodium citrate). These shall not be limiting as other salts can be utilized herein without departing from the scope of the present disclosure.

In certain embodiments, the interleaving material may include one or more of polypropylene glycol and sodium gluconate. For example, in certain embodiments, the interleaving material includes interleaving particles and/or beads, a layer of polypropylene glycol, and a stain-inhibiting organic acid or salt thereof. In some embodiments, the interleaving particles and/or beads are formed of (e.g., include) polypropylene glycol. In some embodiments, the interleaving particles and/or beads include cellulose (e.g., are cellulose-based interleaving particles and/or beads). In some embodiments, the polypropylene glycol forms a coating on the surface of the interleaving particles and/or beads. In some embodiments, the stain-inhibiting organic acid adheres (e.g., impinges, enrobes, etc.) to the interleaving particles/beads, the coating of polypropylene glycol, or a combination thereof. In some embodiments, the interleaving material has a select particle size, such as the particle sizes disclosed herein. In some embodiments, the interleaving material further includes sodium gluconate particles which may be similar in size to the interleaving particles and/or beads. In some embodiments, the interleaving material further includes one or more additional stain-inhibiting organic acids, such as adipic acid.

To prepare interleaving materials comprising interleaving polymer-containing particles or beads enrobed or impinged with stain-inhibiting organic acids or salts thereof, methods such as spray drying, milling, extruding, or coating processes, or combinations thereof, can be utilized. In some embodiments, spray drying is utilized for thermally sensitive polymers to prevent, for example, decomposition or degradation thereof. Any spray drying process or apparatus known in the art can be utilized herein to prepare interleaving materials. For example, a solution or slurry of a stain-inhibiting organic acid can be fed to a spray dryer apparatus where said solution or slurry is atomized and administered through a spray nozzle configured to disperse the solution over the interleaving polymer-containing particles or beads. Advantageously, spray dryers afford a high degree of control over the droplet size of the liquid or slurry being dispersed. Following the dispersing, the interleaving polymer-containing particles or beads are enrobed or impinged with the stain-inhibiting organic acid, which are then subjected to a hot gas to flash off solvent and obtain enrobed and/or impinged interleaving material.

Other processes can combine extrusion processes with milling processes to produce the interleaving materials. For example, in some embodiments, a solution or slurry comprising a stain-inhibiting organic acid that be prepared and combined with the interleaving polymer-containing particles or beads. The resulting mixture can extruded or coated onto a belt using, for example, rollers, bar-coaters, slot-die-coaters, blade-coaters, knife-coaters, roll-coaters, wire-bar coaters, dip-coaters, and spray-coaters, etc. The extruding or coating can then be subjected to drying. Non-limiting examples of drying include heating, evaporating, irradiating with ultraviolet radiation, among other techniques known in the art, to form a film. The film can further be subjected to fracturing processes, such as milling to obtain enrobed and/or impinged interleaving material. Non-limiting examples of milling include hammer milling, pin milling, and ball milling (e.g., dry ball milling), among other techniques.

### SEQUESTERING INTERLEAVING MATERIALS

Embodiments of the present disclosure further include interleaving materials comprising interleaving particles or beads, wherein the interleaving particles or beads comprise an ion exchange resin, wherein the ion exchange resin is configured to sequester ions leached from glass. In some embodiments, ions, such as sodium, are sequestered within the interleaving particles or beads. For example, in certain embodiments, one or more ions, such as sodium, may be sequestered within an interleaving particle or bead comprising an ion exchange resin.

The ion exchange resin can include a cation exchange resin or anion exchange resin, or a combination thereof, or preferably a cation exchange resin. The ion exchange resin can be selective for specific ions, depending on the type of glass with which the interleaving materials are intended to be used and/or depending on the environment of the intended use. In some embodiments, the interleaving materials comprise at least two interleaving particles or beads, the at least two interleaving particles or beads being different. For example, a mixture of interleaving beads can be provided, each comprising a different ion exchange resin. Accordingly, in some embodiments, the interleaving materials comprise a first interleaving bead comprising a first ion exchange resin and a second interleaving bead comprising a second ion exchange resin, wherein the first and second ion exchange resin are optionally different.

Suitable cation exchange resins can include, but are not limited to, polystyrene, polyethylene, polyvinyl chloride, polyvinyl acetate, polyethylene imine and other polyalkylene imines, polyvinyl pyridine, polyacrylonitrile, polyacrylates, Saran®, Teflon® and the like, any one of which can optionally be cross-linked. In addition or in the alternative, the cation exchange resins can include acrylic resins derived from methyl acrylate, ethyl acrylate, butyl acrylate, methylmethacrylate, acrylonitrile, acrylic acids, or combinations thereof. In some embodiments, the acrylic resins are cross-linked with a cross-linking agent, such as divinyl benzene, among others. In some embodiments, the ion exchange resins comprise functional groups. Examples of such functional groups include, but are not limited to, carboxylic acid, sulfonic or sulfuric acids, acids of phosphorus such as phosphonous, phosphonic or phosphoric, and the like.

The cation exchange resins comprise a mobile cation as a counterion to a fixed anion. The cation exchange resins can be generated or regenerated with mobile cations specific or selective for being exchanged with the cation leached from the glass, such as sodium ions in soda-lime-silica glass. The mobile cations of the cation exchange resin are thus not particularly limited. In some embodiments, the cation exchange resin comprises, as a mobile cation, one or more of the following cations: H⁺, Na⁺, Mg²⁺, Ca²⁺, and the like. The anion is similarly not particularly limited and can be selected from any suitable anion, depending on the chemistry of the ion exchange resin, among other considerations.

The bead or particle size or average bead or particle size of the ion exchange resins can be in the range of 0.01 micron to about 3 mm, preferably at least about 0.1 mm or greater, or any incremental subrange or size between 0.01 micron and 3 mm.

### SCAVENGING INTERLEAVING MATERIALS

Embodiments of the present disclosure further include interleaving materials comprising an interleaving material, wherein the interleaving material comprises a functionalized porous media comprising functional groups that scavenge or react with ions leached from glass.

The functionalized porous media is preferably macroporous separation media, but in some instances can include microporous, mesoporous, and/or nanoporous separation media as well. The functionalized porous media can be provided in the form of freestanding membranes and/or thin films, as well as supported membranes and/or thin films, including, for example, asymmetric membranes, among others. The functionalized porous media can have a characteristic of hydrophilicity or hydrophobicity. The functionalized porous media utilized herein can include organic, inorganic, or hybrid organic-inorganic materials. Examples of suitable organic materials include polymer membranes, such as cast polymer membranes, melt-blown polymer membranes, hollow fiber membranes, flat sheet membranes, and the like. In some embodiments, the porous media comprise one or more of diatomaceous earth, alumino silicate, silica, alumina, zirconia, magnesia, boria, phosphate, titania, ceria, thoria, alumina-phosphorous oxide, silica alumina, zeolite modified inorganicoxides, e.g., silica alumina, perovskites, spinels, aluminates, silicates, e.g., zirconium silicate, mixtures thereof, and the like.

The functionalized porous media can comprise a functional group. The functional group can be selected to react with a particular ion or combination of ions that leach from a specific type of glass. In some embodiments, the functional group is selected for halides, such as Br, Cl, or I. In other embodiments, the functional group includes one or more of the following: hydroxyl, carboxylic acid, anhydride, acyl halide, alkyl halide, aldehyde, alkene, amide, amine, thiol, sulfonate, sulfonic acid, sulfonyl ester, carbodiimide, ester, cyano, epoxide, proline, disulfide, imidazole, imide, imine, isocyanate, isothiocyanate, nitro, or azide. Preferably, the functional group is selected such that the reaction product of the functional group with the ion is not an alkaline species.

### APPLICATIONS OF INTERLEAVING MATERIALS

Embodiments further include applications of interleaving materials. The applications can include methods of applying interleaving materials comprising disposing a plurality of interleaving materials onto a surface of a glass article. The disposing can include contacting the plurality of interleaving materials with a surface of a glass article. Preferably, the disposing is conducted such that substantially all the interleaving materials are contacted with a glass surface to minimize losses and waste. The interleaving materials can be selected form any of the interleaving materials disclosed herein including, for example, neutralizing interleaving materials, sequestering interleaving materials, and scavenging interleaving materials. The glass article is any article comprising glass and thus is not particularly limited. An example of an exemplary glass article is glass sheets, preferably stacked glass sheets. The glass article can be uncoated or coated (e.g., coated with a low-emissivity or low-E coating, among others). Advantageously, the interleaving particles disclosed herein can be applied and adhere to both coated and uncoated glass articles.

### EXAMPLE 1

### Interleaving Materials

Interleaving materials may include cellulose-based beads enrobed/impinged with sodium gluconate, among other things. For example, a cellulose-based bead may optionally be coated with propylene glycol (PPG). The coating process may involve vaporizing PPG and applying the vaporized PPG to the surface of the cellulose-based beads, optionally in combination with fluidized air mixing. The PPG-coated cellulose-based beads may be screened using, for example, meshes, wherein the PPG would function as a static eliminator to provide improved screenability. The screening may be utilized to obtain interleaving materials with more consistent and/or uniform particle sizes. The PPG-coated cellulose-based beads may be contacted (e.g., mixed) with very fine sodium gluconate, wherein the PPG coating on the surface of the cellulose-base beads promotes adhesion of the sodium gluconate to a surface of said PPG coating. The resulting interleaving material may include cellulose-based beads enrobed with sodium gluconate, optionally with a PPG coating layer between a surface of the cellulose-based beads and the sodium gluconate. The sodium gluconate may be the active ingredient used to maintain stable pH in a packing system for glass where water is present. The sodium gluconate may also reduce the rate that sodium leaches from glass. The sodium gluconate may sequester any sodium ions (e.g., which leach from within the glass) to prevent, reduce, or eliminate corrosion.

### EXAMPLE 2

### Interleaving Materials

The interleaving materials from Example 1 may further include standalone or independent sodium gluconate particles. For example, the interleaving materials from Example 1 may be combined with sodium gluconate particles. The sodium gluconate particles may have a particle size similar to the particle size of the cellulose-based beads and/or at a particle size larger than the average size of the sodium gluconate adhered to the PPG surface and/or cellulose-based bead surface.

### EXAMPLE 3

### Interleaving Materials

The interleaving materials from Example 1 and/or Example 2 may further include one or more addition stain-inhibiting organic acids. For example, other carboxylic acids may be used. More specifically, the interleaving material from Example 1 may be further combined with another carboxylic acid (which may be in solid form, such as a powder), such as adipic acid. The interleaving material from Example 2 may be further combined with another carboxylic acid (which may be in solid form, such as a powder), such as adipic acid. Other carboxylic acids may be used in addition to adipic acid which is only provided as an example.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A stain-inhibiting interleaving material, comprising:
an interleaving polymer-containing particle or bead enrobed or impinged with stain-inhibiting organic acids or salts thereof.

2. The material of claim 1, wherein the interleaving polymer-containing particle or bead comprises a polymer material selected from the group consisting of: polymethylmethacrylate, polyethylene, polystyrene, polytetrafluoroethylene, polyvinylpyrrolidone, acrylic beads, nylon, polypropylene, polypropylene glycol (PPG), polyethylene, divinylbenzene, polyvinyl, polyvinyl difluoride, high density polyvinyl difluoride, polyacrylamide, phenolic resins, melamine resins, epoxy resins, silicone resins, polyimides, a (C2-C6) monoolefin polymer, a vinylaromatic polymer, a vinylaminoaromatic polymer, a vinylhalide polymer, a (C1-C6) alkyl (meth)acrylate polymer, a(meth)acrylamide polymer, a vinyl pyrrolidone polymer, a vinyl pyridine polymer, a (C1-C6)hydroxyalkyl (meth)acrylate polymer, a (meth)acrylic acid polymer, an acrylamidomethylpropylsulfonic acid polymer, an N-hydroxy-containing (C1-C6) alkyl(meth)acrylamide polymer, acrylonitrile; polyglycolide, polylactic acid, polycaprolactone, polyethylene adipate, polyhydroxylalkanoate, polyhydroxybutyrate, poly(3-hydroxybutyrate-co-3-hydroxyvalerate), polyethylene terephthalate, polybutylene terephthalate, polytrimethylene terephthalate, polyethylene naphthalate, and cellulose material.

3. The material of claim 2, wherein the cellulose material includes one or more of nitrocellulose, cellulose acetate, cellulose triacetate, cellulose propionate, cellulose acetate propionate, cellulose acetate butyrate, cellulose sulfate, methylcellulose, ethylcellulose, ethyl methyl cellulose, hydroxyethyl cellulose, hydroxyethyl methyl cellulose, hydroxypropyl methyl cellulose, ethyl hydroxyethyl cellulose, carboxymethyl cellulose, rayon cellulose, viscose cellulose, lyocell cellulose, and modal cellulose.

4. The material of claim 1, wherein the stain-inhibiting organic acid is selected to neutralize alkali ions, alkaline earth ions, or any combination thereof.

5. The material of claim 1, wherein the stain-inhibiting organic acid includes a sodium salt, potassium salt, ammonium salt, calcium salt, or magnesium salt of an organic acid.

6. The material of claim 1, wherein the stain-inhibiting organic acid includes at least one of gluconic acid, stearic acid, palmitic acid, citric acid, tartaric acid, malic acid, DL-tropic acid, glyceric acid, aldonic acids, maleic acid, sebacic acid, succinic acid, saccharic acid, mannaric acid, salicylic acid, adipic acid, stearic acid, itaconic acid, lactic acid, sodium acetate, boronic acid, fumaric acid, benzoic acid, or an oganotin compound.

7. The material of claim 1, further comprising a coating layer of polypropylene glycol on a surface of the interleaving polymer-containing particle or bead, wherein the coating layer promotes adhesion of the stain-inhibiting organic acids or salts thereof.

8. A stain-inhibiting interleaving material, comprising:
an interleaving particle or bead, wherein the interleaving particle or bead comprises an cation exchange resin, wherein the cation exchange resin is configured to sequester cations leached from glass.

9. The material of claim 8, wherein the cation exchange resin includes polystyrene, polyethylene, polyvinyl chloride, polyvinyl acetate, polyethylene imine and other polyalkylene imines, polyvinyl pyridine, polyacrylonitrile, or polyacrylates.

10. The material of claim 8, wherein the cation exchange resin includes an acrylic resin derived from methyl acrylate, ethyl acrylate, butyl acrylate, methylmethacrylate, acrylonitrile, acrylic acids, or combinations thereof.

11. The material of claim 8, wherein the cation exchange resin is a first cation exchange resin and the stain-inhibiting interleaving material further comprises a second cation exchange resin.

12. A stain-inhibiting interleaving material, comprising:
an interleaving material, wherein the interleaving material comprises a functionalized porous media comprising functional groups that scavenge or react with ions leached from glass.

13. The material of claim 12, wherein the functionalized porous media is selected from organic materials, inorganic materials, or hybrid organic-inorganic materials.

14. The material of claim 13, wherein the organic materials are selected from cast polymer membranes, melt-blown polymer membranes, hollow fiber membranes, or flat sheet membranes.

15. The material of claim 12, wherein the functionalized porous media comprises a functional group selected from the group consisting of hydroxyl, carboxylic acid, anhydride, acyl halide, alkyl halide, aldehyde, alkene, amide, amine, thiol, sulfonate, sulfonic acid, sulfonyl ester, carbodiimide, ester, cyano, epoxide, proline, disulfide, imidazole, imide, imine, isocyanate, isothiocyanate, nitro, or azide.

16. A method of applying interleaving materials, comprising:
disposing a plurality of interleaving materials onto a surface of a glass article.

17. The method of claim 16, wherein the interleaving materials adhere to the surface of the glass article.

18. The method of claim 16, wherein the glass article is a plurality of glass sheets arranged into stacks.

19. The method of claim 16, wherein less than 10% of the interleaving materials are lost as waste.

20. The method of claim 16, wherein less than 5% of the interleaving materials are lost as waste.
